(19) United States
(12) Patent Application Publication
(10) Pub. No.: US 2014/0163745 A1
(43) Pub. Date: Jun. 12, 2014

(54) Method for Optimizing the Configuration of Distributed CCHP System

(71) Applicant: Guangdong Electric Power Design Institute of China Energy Engineering Group Co., Ltd., Guangdong (CN)

(72) Inventors: Xuesong Ma, Guangdong (CN); Bo Hu, Guangdong (CN); Yongchun Fan, Guangdong (CN); Zehan Chen, Guangdong (CN); Xueping Peng, Guangdong (CN); Bin Ge, Jiangsu (CN); Junli Zhang, Jiangsu (CN); Yongming Hua, Jiangsu (CN); Wei Leng, Jiangsu (CN); Jiamin Yin, Guangdong (CN); Linwei Li, Guangdong (CN); Zhanpeng Liang, Guangdong (CN); Miaomiao Han, Zhejiang (CN); Jing Qi, Jiangsu (CN); Xiang Xu, Guangdong (CN); Yuhua Chen, Guangdong (CN); Chunrong Cai, Guangdong (CN)

(73) Assignee: Guangdong Electric Power Design Institute of China Energy Engineering Group Co., Ltd., Guangdong (CN)

(21) Appl. No.: 14/104,100

(22) Filed: Dec. 12, 2013

(30) Foreign Application Priority Data
Dec. 12, 2012 (CN) 201210537150.7

(51) Int. Cl. G05B 13/04

(52) U.S. Cl. CPC G05B 13/04
USPC 700/276

(57) ABSTRACT

A method for optimizing the configuration of a distributed CCHP system is disclosed. The method includes: creating a digital model database containing digital models of various energy use, conversion forms in the distributed CCHP system; creating a feasible configuration solution database according to load demands, constraints and combined screening strategy, wherein the total number of the configuration solutions in the configuration solution database is set as N; performing an all-year hourly operational strategy optimization on each configuration solution in the configuration solution database, based on an annual load demand curve, until the annual operating costs, annual one-time energy consumption and annual pollutant emission of the i^{th} configuration solution are calculated, wherein i≧N; selecting a configuration solution with characteristics selected from the group consisting of the least annual operating costs, the least annual one-time energy consumption, the least amount of annual pollutant emission, and any combination thereof, as the optimal configuration solution.

### FIELD OF THE INVENTION

The present invention relates generally to the field of distributed combined cooling, heating and power (CCHP) system, and more particularly to a method for optimizing the configuration of a distributed CCHP system.

### BACKGROUND OF THE INVENTION

The optimization of system configuration of distributed CCHP system is one of the key technologies for making full use of the advantages of a distributed CCHP system, these advantages including high efficiency, energy saving, and low-carbon emission. The existing methods for optimizing the configuration of distributed CCHP system generally employ calculating, comparing and selecting solutions by human. According to system demands for cold, heat and electricity load, as well as other boundary conditions, a number of alternative solutions for system configuration are manually selected, further analyzed and calculated, so as to select the preferable configuration solutions. However, the existing methods for optimizing the configuration have some disadvantages.

(1) Due to the complexity and the strong coupling characteristic of CCHP system, manually selecting a number of alternative solutions of system configuration will lead to the fact that the optimal solution can not appear in the final solutions.

(2) Human analysis and calculation of the system may only calculate one or several design conditions of the system, which fails to reflect the actual operation condition of the system.

(3) Human analysis and calculation for configuration optimization is time consuming with poor optimization results.

### SUMMARY OF THE INVENTION

Based on the above, there is a need to provide a method for optimizing the configuration of a distributed CCHP system.

According to an aspect of the present invention, a method for optimizing the configuration of a distributed combined cooling, heating and power (CCHP) system is provided, wherein the method includes the steps of:

creating a digital model database containing digital models of various energy use, conversion forms in the distributed CCHP system, wherein the digital model database includes energy model, cost model and pollutant emission model;

creating a configuration solution database containing feasible configuration solutions according to load demands, constraints and combined screening strategy, wherein the total number of the configuration solutions in the configuration solution database is set as N;

performing an all-year hourly operational strategy optimization on each configuration solution in the configuration solution database, based on an annual load demand curve, until the annual operating costs, annual one-time energy consumption and annual pollutant emission of the i^{th} configuration solution are calculated, wherein i≧N;

selecting a configuration solution with characteristics selected from the group consisting of the least annual operating costs, the least annual one-time energy consumption, the least amount of annual pollutant emission and any combination thereof, as the optimal configuration solution.

The present invention makes improvements to the configuration optimization of distributed CCHP system. By mathematical modeling of thermal equipments and the overall system, optimization of the system configuration is achieved by computer algorithms, with all possible configuration solutions are incorporated within the optimization range, ensuring the overall optimality of the results. The optimization of system configuration involves two levels, i.e., optimization of configuration solutions and optimization of operation, ensuring that the optimal results can reflect the actual operation condition of the system. By the optimization using computer program, automation is realized, saving time and efforts, while gaining better optimization effect.

In a preferred embodiment, the method further includes the step of: establishing energy model based on the law of mass balance, the law of energy balance and the law of momentum conservation; establishing cost model based on the principles of economics; establishing model of pollution emission based on fuel type, fuel combustion characteristics and characteristics of environmental protection equipment. The purpose is to facilitate the process combined modeling, and to simulate the energy, economic and environmental protective characteristics of the distributed CCHP system.

In a preferred embodiment, the method further includes the steps of establishing subsystem model of the distributed CCHP system, with modules of various equipments combined to form triple supply, dual supply and single supply subsystems. The purpose is to adapt the algorithm of optimization calculation.

In a preferred embodiment, the method further includes the steps of: creating objective functions of system optimization, which include single objective functions of energy-consuming objective, economic objective and environmental protection objective, or multi-objective functions of any combination of the energy-consuming objective, economic objective and environmental protection objective. When constructing the objective functions, the above various possibilities should be taken into account to meet different optimization speeds. By use of effective optimization algorithms directed specifically to the constructed objective function of optimization and its evaluation index system, two levels of optimization can be achieved, including the optimization of energy configuration solution and optimization of operation mode and strategy.

The present invention has the following advantages.

(1) By mathematical modeling applied to the thermal equipments and the overall system, and computer algorithms used to achieve optimization of the system configuration, all possible configuration solutions are incorporated within the optimization range, ensuring the overall optimality of the results;

(2) The optimization involves two levels, i.e., optimization of configuration solutions and optimization of operation. Each solution is applied with all-year hourly operation mode and strategic optimization, which ensures a whole temporal range of the optimization, and further ensures that the optimal results can reflect the actual operation condition of the system.

(3) The optimization objectives include three indexes; i.e., energy efficiency, economy and environmental protection, and the comprehensive index thereof, which conforms to the current development trend of energy saving and environmental protection, achieving multi-objective optimization and system comprehensive optimization.

(4) By using computer software to achieve optimization of system configuration, human cost for design and consulting is significantly reduced, while the quality of the optimization solutions is guaranteed.

(5) In the preliminary design phase of the distributed CCHP system, by introducing the technical solution of the present invention to optimize the design of the system configuration, it is able provide quality consulting services, making full use of the advantages of the distributed CCHP system, i.e., high efficiency, energy saving, low-carbon emission and environmental protection, so as to create better economic efficiency and social benefits.

### BRIEF DESCRIPTION OF THE DRAWINGS

FIG. 1 is the flow chart of the method for optimizing the configuration of the distributed CCHP system in one embodiment of the present invention.

### DETAILED DESCRIPTION OF THE PREFERRED EMBODIMENTS

The invention will be better understood with reference to the following description taken in conjunction with the specific embodiment and the accompanying drawings.

### EXAMPLE

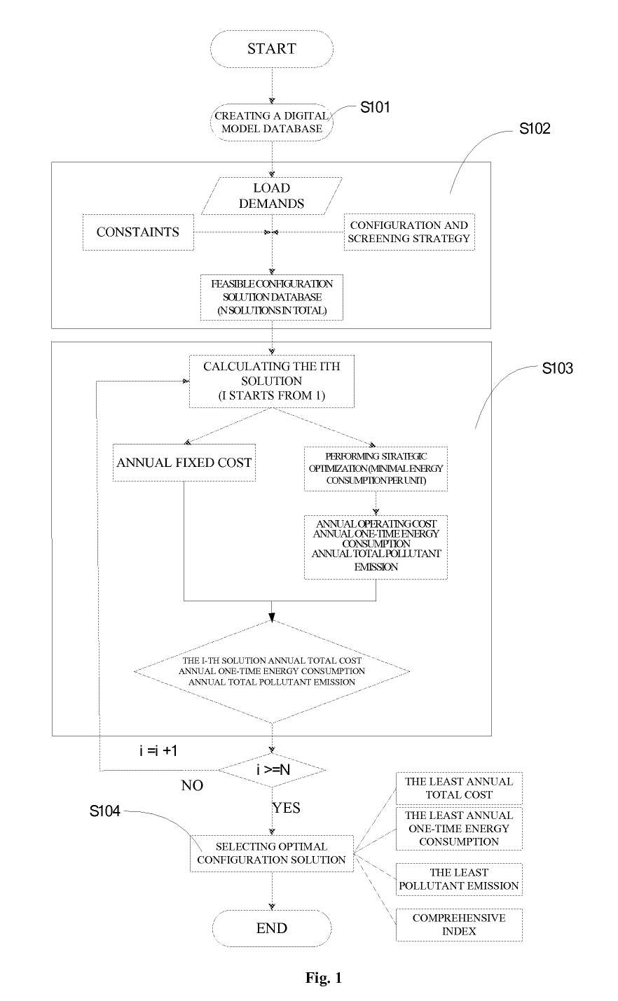

As shown in FIG. 1, a method for optimizing the configuration of a distributed CCHP system includes the steps of:

Step S101: Creating a digital model database containing digital models of various energy use, conversion forms in the distributed CCHP system, wherein the digital model database includes energy model, cost model and pollutant emission model.

In this step, energy model is established based on the law of mass balance, the law of energy balance and the law of momentum conservation; cost model is established based on principles of economics; model of pollution emission is established based on fuel type, fuel combustion characteristics and characteristics of the environmental protection equipment. The purpose is to facilitate the process combined modeling, and to simulate the energy, economic and environmental protective characteristics of the distributed CCHP system.

In this step, subsystem models of the distributed CCHP system are established, with modules of various equipments combined to form triple supply, dual supply and single supply subsystems. The purpose is to adapt the algorithm of optimization calculation.

In this step, objective functions of system optimization are created, which include single objective functions of energy-consuming objective, economic objective and environmental protection objective, or multi-objective functions of any combination of the energy-consuming objective, economic objective and environmental protection objective. When constructing the objective functions, the above various possibilities should be taken into account to meet different optimization needs. By use of effective optimization algorithms directed specifically to the constructed objective function of optimization and its evaluation index system, two levels of optimization can be achieved, including the optimization of energy configuration solution and optimization of operation mode and strategy.

Step: S102: Creating a configuration solution database containing feasible configuration solutions according to load demands, constraints and combined screening strategy, wherein the total number of the configuration solutions in the configuration solution database is set as N.

Step S103: performing an all-year hourly operational strategy optimization on each configuration solution in the configuration solution database based on an annual load demand curve, until the annual operating costs, annual one-time energy consumption and annual pollutant emission of the i^{th} configuration solution are calculated, wherein i≧N; if i<N, then continuing calculating the next solution.

Step S104: Selecting a configuration solution with characteristics selected from the group consisting of the least annual operating costs, the least annual one-time energy consumption, the least amount of annual pollutant emission, and any combination thereof, as the optimal configuration solution.

The method for optimizing the configuration of distributed CCHP system of this embodiment makes improvements to the configuration optimization of distributed CCHP system. By mathematical modeling of thermal equipments and the overall system, optimization of the system configuration is achieved by computer algorithms, with all possible configuration solutions are incorporated within the optimization range, ensuring the overall optimality of the results. The optimization of system configuration involves two levels, i.e., optimization of configuration solutions and optimization of operation, ensuring that the optimal results can reflect the actual operation condition of the system. By the optimization using computer program, automation is realized, saving time and efforts, while gaining better optimization effect.

In this embodiment, the data models in the digital model database include models of equipment types of gas turbines, waste heat boilers, internal combustion engines, gas boilers, steam turbines, electric air conditioning, non-electric air conditioning, gas water heaters and other equipments of the distributed CCHP system.

Model structure and parameters can not only reflect the characteristics of the rated design conditions, but also reflect the characteristics of variable conditions. For example, when change occurs in environmental parameters or external load, the evaluation indexes of the system such as efficiency and effectiveness will also change accordingly, ensuring two-level optimization of configuration solution and operation.

Considering the adaption to the optimization algorithm, subsystem-level models are mainly used in the CCHP system. According to energy supply characteristics, modules of various equipments are combined to form triple supply, dual supply and single supply subsystems. For subsystem models, data fitting modeling is mainly used.

The objective functions of system optimization include single objective functions of energy-consuming objective, economic objective and environmental protection objective, or multi-objective functions of any combination of the energy-consuming objective, economic objective and environmental protection objective. When constructing the objective functions, the above various possibilities should be taken into account to meet different optimization needs. By use of effective optimization algorithms directed specifically to the constructed objective function of optimization and its evaluation index system, two levels of optimization can be achieved, including the optimization of energy configuration solution and optimization of operation mode and strategy.

Based on the demands for controllability of the process, and for reasonability and feasibility of the results of configuration optimization, as well as for engineering practicability, optimization of configuration solutions is carried out in two levels. The first level is to determine and screening, based on full consideration of the rationality of the combination of subsystems, reasonable and feasible configuration solutions according to feasibility rules including load demands, constraints and combined screening strategy, i.e., to create database of feasible configuration solutions. The second level is to perform all-year hourly strategic optimization on each of the configuration solutions in the solution database based on an annual load demand curve, and to calculate indexes of the annual operating costs, annual one-time energy consumption and annual pollutant emission. When performing strategic optimization, load distribution is implemented with the object of the least energy consumption per unit, and the overall configuration uses single objective or multi-objective optimization method. The single object includes three types of objectives: the least total annual cost (total annual cost consisting of annual fixed cost and annual operating) cost), the least one-time annual cost and the least amount of annual emission (CO₂, SO₂ and NOₓ), wherein the total annual cost consists of annual fixed costs and annual operating costs; while by the multi-objective method, the effect of three indexes are taken into account: the total annual cost, one-time annual cost and annual pollutant emission.

The above is a preferred embodiment of the invention, and the scope of the present invention is defined by the appended claims rather than the foregoing description and the exemplary embodiments described therein. Alternative embodiments will become apparent to those skilled in the art to which the present invention pertains without departing from its spirit and scope.

What is claimed is:

1. A method for optimizing the configuration of a distributed combined cooling, healing and power (CCHP) system, comprising:
creating a digital model database containing digital models of various energy use, conversion forms in the distributed CCHP system, wherein the digital model database comprises energy model, cost model and pollutant emission model;
creating a configuration solution database containing feasible configuration solutions, according to load demands, constraints and combined screening strategy, wherein the total number of the configuration solutions in the configuration solution database is set as N;
performing an all-year hourly operational strategy optimization on each configuration solution in the configuration solution database, based on an animal load demand curve, until the annual operating costs, annual one-time energy consumption and annual pollutant emission of the i^{th} configuration solution are calculated, wherein i≧N;
selecting a configuration solution with characteristics selected from the group consisting of the least annual operating costs, the least annual onetime energy consumption, the least amount of annual pollutant emission, and any combination thereof, as the optimal configuration solution.

2. The method of claim 1, further comprising:
establishing an energy model based on the law of mass balance, the law of energy balance and the law of momentum conservation;
establishing a cost model based on the principles of economics;
establishing a pollution emission model based on fuel type, fuel combustion characteristics and characteristics of environmental protection equipment.

3. The method of claim 1, further comprising:
establishing subsystem model of the distributed CCHP system, with modules of various equipments combined to form triple supply, dual supply and single supply subsystems.

4. The method of claim 2, further comprising:
establishing subsystem model of the distributed CCHP system, with modules of various equipments combined to form triple supply, dual supply and single supply subsystems.

5. The method of claim 3, further comprising:
creating objective functions of system optimization, wherein the objective functions comprise single objective functions of energy-consuming objective, economic objective and environmental protection objective, or multi-objective functions, of any combination of the energy-consuming objective, economic objective and environmental protection objective.

6. The method of claim 4, further comprising:
creating objective functions of system optimization, wherein the objective functions comprise single objective functions of energy-consuming objective, economic objective and environmental protection objective, or multi-objective functions of any combination of the energy-consuming objective, economic objective and environmental protection objective.
